(19) United States
(12) Patent Application Publication
(10) Pub. No.: US 2005/0249481 A1
(43) Pub. Date: Nov. 10, 2005

(54) Storage medium storing application data providing programming function, and apparatus and method for reproducing the application

(75) Inventors: Kwang-min Kim, Anyang-si (KR); Jung-ho Lee, Yongin-si (KR); Kil-soo Jung, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/113,185

(22) Filed: Apr. 25, 2005

(30) Foreign Application Priority Data
Apr. 30, 2004 (KR) 2004-30457

(51) Int. Cl. H04N 11/02

(52) U.S. Cl. 386/33

(57) ABSTRACT

A storage medium storing application data providing a programming function, and an apparatus and method of reproducing the application data recorded on the storage medium and application data downloaded through a network. The apparatus includes: a reader reading data recorded on the storage medium; a local storage storing data downloaded from an external database via a network; and a reproducer reproducing the data read from the storage medium and the downloaded data stored in the local storage, wherein the reproducer includes an application manager to control the read data and the downloaded data to be reproduced together. It is possible to provide interactive functions with users, easily update and add application data when the application includes errors and malfunction which are not available when a storage medium is manufactured, or when it is necessary to update the application in order to provide additional functions which are not available when the storage medium is manufactured.

### CROSS-REFERENCE TO RELATED APPLICATION

This application claims the benefit of Korean Patent Application No. 2004-30457, filed on Apr. 30, 2004 in the Korean Intellectual Property Office, the disclosure of which is incorporated herein by reference.

### BACKGROUND OF THE INVENTION

1. Field of the Invention

The present invention relates to the reproduction of application data recorded on a storage medium, and more particularly, to a storage medium storing application data providing a programming function, and an apparatus and method for reproducing the application data recorded on the storage medium and application data downloaded through a network.

2. Description of the Related Art

Moving-image data recorded on a conventional recording medium such as DVDs contains audio-visual (AV) data that is compression-encoded and navigation data that is needed to control the reproduction of the AV data.

Specifically, the AV data includes an AV stream composed of video, audio and/or subtitles, which are encoded according to a motion picture experts group (MPEG) standard. The AV data may further include additional information, such as encoding properties of an AV stream or an entry point for random access, and a play list, which is an object for arranging the order of reproducing moving-images.

Navigation data includes navigation commands for controlling the reproduction of the AV data. Examples of the navigation commands include a command to reproduce a play list and a command to jump to another play list. The AV data can be reproduced with reference to navigation information recorded in a storage medium, and thus a user can watch a high-quality moving-image such as a movie. However, after moving-image data having the above data structure is recorded when manufacturing the medium, it is difficult to edit and correct AV data, or to record application data providing an interactive function with a user. Therefore, a storage medium storing application data providing a programming function in addition to moving-image data is required.

The application data providing the programming function may be obtained using a program language such as C or Java. However, the application data providing the programming function may not be compatible with moving-image data having a conventional static data structure, which is recorded when a storage medium is manufactured. As such, it is necessary to update the application data in order to provide additional functions which are not available when the storage medium is manufactured.

### SUMMARY OF THE INVENTION

According to an aspect of the present invention, there is provided a storage medium storing an application providing a programming function, and an apparatus and method of reproducing the application recorded on the storage medium and an application downloaded through a network.

According to an aspect of the present invention, there is provided an apparatus reproducing data recorded on a storage medium providing an interactive function, the apparatus including: a reader reading data recorded on the storage medium; a local storage storing data downloaded from an external database via a network; and a reproducer reproducing the data read from the storage medium and the downloaded data stored in the local storage, wherein the reproducer includes an application manager to control the read data and the downloaded data to be reproduced together.

According to an aspect of the present invention, the application manager may combine the read data with the downloaded data in a system memory and reproduce the combined data.

According to another aspect of the present invention, the read data and the downloaded data may include application data providing interactive functions and management information to control the application data and the application manager may update management information read from the storage medium in the system memory using the management information downloaded and stored in the buffer.

According to an aspect of the present invention, the application manager may replace the management information read from the storage medium with the management information downloaded and stored in the buffer, and store the replaced management information in the system memory when the management information downloaded and stored in the buffer is the same as the management information read from the storage medium, the application manager may compare names of applications included in the both management information, and/or file names of applications in order to check whether the management information downloaded and stored in the buffer is the same as the management information read from the storage medium.

According to an aspect of the present invention, the application manager may add the management information downloaded and stored in the buffer to the management information read from the storage medium, and store the added management information in the system memory when the management information downloaded and stored in the buffer is not the game as the management information read from the storage medium.

According to an aspect of the present invention, the local storage may include separate storage regions divided by dividers of the storage medium, and store the application data and the management information in the divided storage regions, and the management information include property information of the application and operation information of the application.

According to an aspect of the present invention, the property information of the application may contain at least one of a name of the application data, a name of a file of the application data, a position of the file, version information of the application data, or title information including the application data. The operation information of the application may contain at least one of a starting and ending method of the application, a starting and ending time of the application, a suspend method and time of the application, preload information of the application data, or execution start parameter information.

According to an aspect of the present invention, the local storage may store at least one piece of downloaded application data and at least one piece of downloaded management information in each of divided storage regions or at least one piece of downloaded application data or management information corresponding to at least one piece of the downloaded application data in each of divided storage regions.

According to an aspect of the present invention, the storage medium may be easily removed from and inserted into the reproducing apparatus, and may be an optical disk capable of being read using an optical device.

According to another aspect of the present invention, there is provided a method of reproducing a storage medium on which moving-image data and application data providing an interactive function using the moving-image data are recorded, the method including: reading data recorded on the storage medium; storing data downloaded from an external database via a network on a local storage; and combining the data read from the storage medium with the downloaded data stored in the local storage and reproducing the combined data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates types of data recorded on a storage medium according to an embodiment of the present invention;

FIG. 2 is a block diagram of a reproducing apparatus according to an embodiment of the present invention;

FIG. 3 illustrates a structure of application data stored in a local storage illustrated in FIG. 2;

FIG. 4 illustrates another structure of application data stored in the local storage illustrated in FIG. 2;

FIG. 5 is a flowchart illustrating a method of reproducing application data by inserting a storage medium into a reproducing apparatus according to an embodiment of the present invention; and

FIG. 6 is a flowchart illustrating a method of reproducing application data when downloading is completed according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

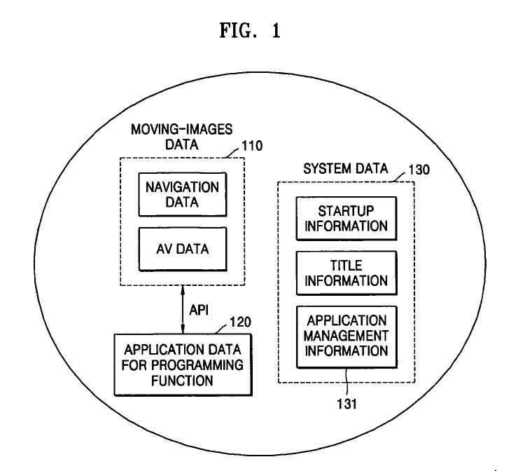

FIG. 1 illustrates types of data recorded on the storage medium according to an embodiment of the present invention. Referring to FIG. 1, the storage medium has moving-images data 110, application data 120 for a programming function (hereinafter referred to as application data), and system data 130 recorded thereon.

The moving-images data 110 used for reproducing moving-images is referred to as core mode data or movie mode data. The moving-images data 110 includes AV data that is compression-encoded and navigation data for controlling the reproduction of AV data. Therefore, the AV data can be reproduced with reference to the navigation data recorded on the storage medium, and a user can watch high-quality moving-images such as movies.

The application data 120 used to provide interactive functions with the user is referred to as full mode data. The application data 120 may provide a variety of applications offering a game function using moving-images, a function for displaying a director's commentary while reproducing a portion of a moving-image, a function for displaying additional information while reproducing a portion of a moving-image, or a chatting function while reproducing a moving-image.

If a movie has been recorded on the storage medium, information related to the movie such as the latest news about actors/actresses starring in the movie, events related to the movie, or updated subtitles, which are stored on a web page or in a database, can be retrieved and reproduced together with the movie.

To execute an application program while reproducing a moving-image, the application data 120 may include an application program interface (API) function for a presentation engine that reproduces moving-image information. The application data 120 is implemented using a program language such as C or JAVA. In particular, the present invention will describe a JAVA application such as xlet.

The system data 130 includes start-up information, title information, and application management information 131. Start-up information includes information on the position of data to be first reproduced by a reproducing apparatus. Title information includes information on entry and property of data operated when each title is reproduced. The application management information 131 includes information on various properties and operations for reproducing the application data 120.

The storage medium according to an embodiment of the present invention includes the application data 120 for the programming function in addition to the moving-images data 110, thereby reproducing a moving image and providing a variety of interactive functions with the user.

A reproducing apparatus according to an embodiment of the present invention can reproduce application data downloaded from an external database via a network along with the application data 120 recorded on the storage medium shown in FIG. 1.

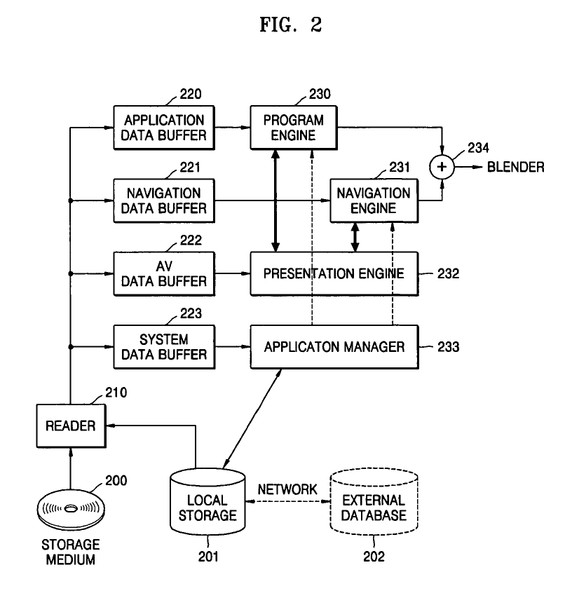

FIG. 2 is a block diagram of the reproducing apparatus according to an embodiment of the present invention. Referring to FIG. 2, the reproducing apparatus includes a reader 210, buffers 220 through 223, and reproducers 230 through 234. In particular, the reproducers 230 through 234 include an application manager 233 for controlling the reproduction of the application data 120.

The reader 210 can download moving-images data, application data, and/or system data from the storage medium shown in FIG. 1 and from an external database 202 via the network. The reproducing apparatus according to an embodiment of the present invention includes a local storage 201 used to store various data including application data downloaded from the external database 202.

The reader 210 reads moving-images data, application data, and/or system data from a storage medium 200 or the local storage 201 and buffers them in each of the buffers 220 through 223. The local storage 201 is used to store the moving-images data, the application data, and/or the system data downloaded from the external database 202 via the network.

The buffers 220 through 223 include an application data buffer 220, a navigation data buffer 221, an AV data buffer 222, and a system data buffer 223. The buffers are provided according to the types of buffered data.

The reproducers 230 through 234 are engines used to reproduce the buffered data. According to the types of buffered data, e.g., application data, navigation data, and AV data, the data is reproduced in a program engine 230, a navigation engine 231, and a presentation engine 232, respectively.

The application manager 233 construes the system data, determines a mode (a core mode or a full mode) and data to be first reproduced, and controls the program engine 230 and the presentation engine 232 to convert a mode during the reproduction or reproduce a title at the request of a user to search the title. In a case of the reproduction in the full mode, the application manager 233 controls the program engine 230 using the application management information 131 shown in FIG. 1, thereby controlling operations of various applications. The application manager 233 transfers a user input to the program engine 230 and the presentation engine 232 in each mode using a user input receiver and a user input processor (not shown) for processing the user input. Furthermore, the application manager 233 manages a process of downloading the application data from the external database 202 via the network, and the local storage 201 to properly store the downloaded application data 120. A module used to manage the downloading and the local storage 201 may be separated from the application manager 233.

The presentation engine 232 decodes and reproduces the AV data, and is controlled by the navigation engine 231. The program engine 230 controls the presentation engine 232 using the API, thereby providing a variety of moving-image applications in the same manner of displaying additional information while reproducing the moving image.

The reproducing apparatus according to an embodiment of the present invention reads and reproduces not only data from the storage medium 200 but also data downloaded from the external database 202 via the network and stored in the local storage 201 under the control of the application manager 233.

It is possible to replace the application data 120 where an application recorded on the storage medium 200 has an error and malfunction which are not expected by a manufacturer of the storage medium 200. It is also possible to provide an application offering additional functions which are not available when the storage medium 200 is manufactured.

The process of downloading application data from the external database 202 via the network and storing the downloaded application data in the local storage 201 is referred to as “download”, and the process of combining the application data stored in the local storage 201 with the application data recorded on the storage medium 200 in a system memory (not shown) is referred to as “update”.

A data structure for reproducing the application data recorded on the storage medium 200 or the local storage 201 will now be described based on the data structure of the storage medium and the structure of the reproducing apparatus according to an embodiment of the present invention.

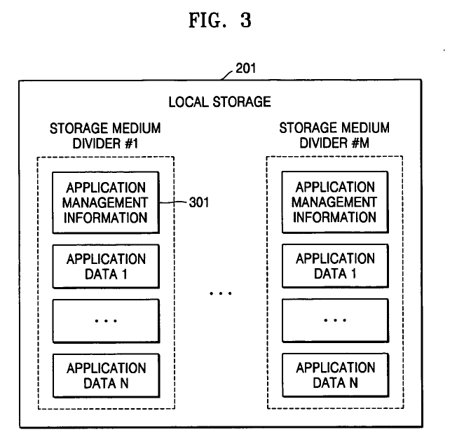

FIG. 3 illustrates a structure of application data stored in the local storage 201 illustrated in FIG. 2. Referring to FIGS. 2 and 3, the local storage 201 downloads from an external database 202 via the network and stores moving-images data, application data, and/or system data. Data stored in the local storage 201 is combined with data recorded on the storage medium 200 in the system memory referred to by the program engine 230 and the presentation engine 232 shown in FIG. 2. In this case, a combining rule is applied when a file structure of the data stored in the local storage 201 is overwritten or added to a file structure of the data recorded on the storage medium 200.

The local storage 201 used to correct an error of application data recorded on the storage medium 200 or store application data having additional functions which are not provided when manufacturing the storage medium 200 will now be described. According to the combining rule, downloaded application files are as follows:
1) In the case where a file name of downloaded application data is the same as that of application data recorded on the storage medium 200, application data recorded in the local storage 201 is used to correct the error of the application data recorded on the storage medium 200 or version-upgraded. Therefore, application management information stored in the local storage 201 is combined with the system memory instead of application management information recorded on the storage medium 200.
2) In the case where the file name of downloaded application data is not the same as that of the application data recorded on the storage medium 200, the application data stored in the local storage 201 is used to provide additional functions which are not provided in the application data recorded on the storage medium 200. Therefore, the application management information stored in the local storage 201 is added to the application management information recorded on the storage medium 200 and combined with the system memory.

Application data is used to execute an application operation using allocated memory in an operational memory (not shown) of the reproducing apparatus. When application data is read from the storage medium 200 and reproduced, the application manager 233 manages the operational memory, and controls the application operation based on the application management information 131 recorded on the storage medium 200. However, when application data downloaded to the local storage 201 is reproduced, since the application management information 131 recorded on the storage medium 200 cannot be used, the operational memory must be managed or the application operation must be controlled using the application data stored in the local storage 201.

To this end, the present invention downloads management information of application data along with the application data. Referring to FIG. 3, the local storage 201 stores a plurality of pieces of application data and management information corresponding to the plurality of pieces of application data. The local storage 201 stores application data and the application management information in regions divided by storage medium dividers. For example, application data and application management information to be substituted or added are stored in separate regions divided by dividers used to divide a storage medium storing a title such as “Lord of the Rings” and a storage medium storing a title such as “The Matrix.”

To be more specific, the application management information includes property information and operation information of application data.

The property information of application data contains a name of the application data, a name of a file of the application data, a position of the file, version information of the application data, and title information including the application data. The name of the application data is used to indicate correlations of the application data recorded on the storage medium 200 and the application data downloaded to the local storage 201. The file name is a name of file data used to operate the application data. The file position is used to indicate a position of the application data stored in the local storage 201. The application manager 233 loads the application data on the operational memory using the file name and the file position of the application data, and controls the application data having the loaded program engine 230 to be executed. The file name and the file position may be expressed as one piece of information. The version information is used to select application data of a desired version when the plurality of applications use the same name. The title information is used to indicate which title is used to operate the application data downloaded to the local storage 201 among titles divided in the storage medium 200.

The operation information of application data includes a starting and ending method of the application, a starting and ending time of the application, a suspend method and time of the application, preload information of the application data, execution start parameter information, and the like. The starting and ending method is used to indicate a start and end command of the application or event information. The starting and ending time is used to indicate time for starting and ending the application, respectively. In this case, time information includes time of the reproducing apparatus or time included in moving-image data being reproduced. The suspend method and time is used to indicate time to stop the reproduction of the application or the command used to suspend the reproduction of the application or event information. In this case, time information also includes time of the reproducing apparatus or time included in moving-image data being reproduced. The preload information of the application data is used to indicate whether the application data is previously read in a preload buffer of the reproducing apparatus when a title including the application is selected before the application is executed. However, in the local storage 201, since the application data can be read using a channel different from the reading of moving-image data, the application management information stored in the local storage 201 may not use the preload information. The execution start parameter information is used to indicate external parameter information necessary for starting to execute the application.

The management information of the application data downloaded to the local storage 201 may have the same structure as the management information of the application data recorded on the storage medium 200 for easy combining or a structure including partial management information of the application data recorded on the storage medium 200.

Referring to FIG. 3, the local storage 201 stores a piece of the application management information and a plurality of pieces of application data in separate regions divided by the storage medium dividers. The storage medium 200 may store the application management information having the same structure as the structure stored in the local storage 201 or a structure including the structure stored in the local storage 201 and a plurality of pieces of application data.

The application data is downloaded from an external database 202 along with related management information of the application data which are added to the application management information 301 stored in the local storage 201, or which are used to update previously stored application management information when the plurality of applications have the same name. The application management information 301 stored in the local storage 201 is added or updated using the application data used for download management, a download management module of the reproducing apparatus, or the application manager 233.

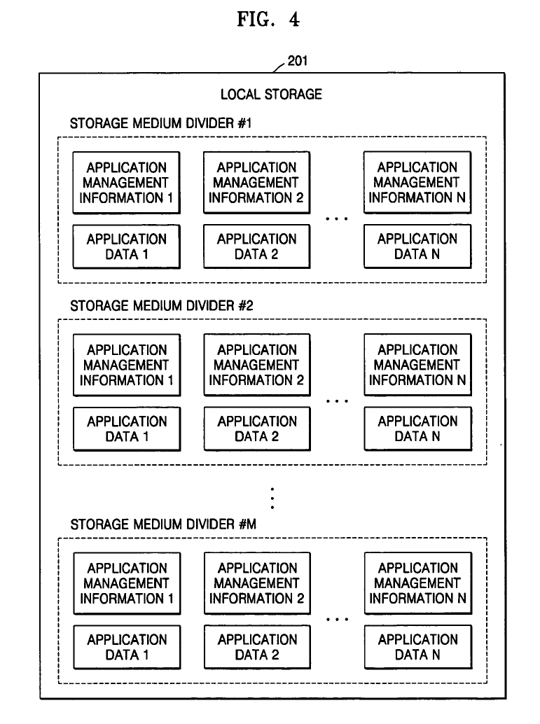

FIG. 4 illustrates another structure of application data stored in the local storage 201 illustrated in FIG. 2. Referring to FIG. 4, the local storage 201 stores a plurality of pieces of application data and a plurality of pieces of application management information corresponding to each of the plurality of pieces of application data which are different from the structure shown in FIG. 3. When application data is downloaded from an external database 202, management information intrinsic to the downloaded application data is separately stored in the local storage 201. Therefore, every piece of application management information may be combined with the system memory using an update command of the application manager 233.

A method of reproducing application data will now be described based on the structure of application data recorded on the storage medium 200 and the local storage 201 and the structure of the reproducing apparatus.

The process of downloading application data from the external database 202 via the network and storing the downloaded application data in the local storage 201 is referred to as “download”, and the process of combining the application data stored in the local storage 201 with application data recorded on the storage medium 200 in the system memory is referred to as “update”. As described above, application data is downloaded and updated along with application management information. In order to combine the application data (FIGS. 3 and 4) downloaded to the local storage 201 with the application data (120 and 131 of FIG. 1) recorded on the storage medium 200 and reproduce the combined data, the application management information can be updated by inserting the storage medium 200 into the reproducing apparatus, or by completing the download using a module used to manage the download or the application manager 233.

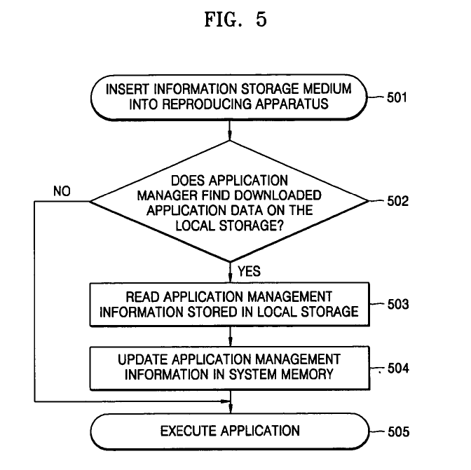

FIG. 5 is a flowchart illustrating a method of reproducing an application by inserting the storage medium into the reproducing apparatus according to an embodiment of the present invention. Referring to FIG. 5, when the reproducing apparatus first reproduces data from the storage medium 200, the application manager 233 included in the reproducing apparatus searches the local storage 201 at an initialization stage and determines whether the local storage 201 includes the downloaded application data (FIG. 3 or FIG. 4) (Operation 502). If the local storage 201 does not include downloaded application data, the application data 120 is executed based on the application management information 131 recorded on the storage medium 200 (Operation 505). If the local storage 201 includes downloaded application data, application management information (FIG. 3 or FIG. 4) stored in the local storage 201 is read (Operation 503) and combined with the application management information 131 recorded on the storage medium 200 in the system memory according to the combining rule (Operation 504). As a result of the combining, newly generated application management information is used to execute an application (Operation 505).

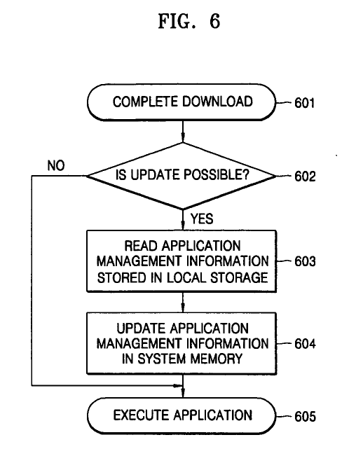

FIG. 6 is a flowchart illustrating a method of reproducing an application when the download is completed according to another embodiment of the present invention. Referring to FIG. 6, while the reproducing apparatus reproduces the data from the storage medium 200, the download is completed using the application manager 233, the separate download management module of the reproducing apparatus, or application data used to manage the download recorded on the storage medium 200. The application manager 233 determines whether update is possible at the present status, i.e., it is possible to combine application management information stored in the local storage 201 in the system memory (Operation 602). Update is impossible while the application data 120 corresponding to the application management information to be updated is executed. Update is possible while the application data 120 corresponding to the application management information to be updated is not executed. If update is impossible, the update command is deferred until the reproduction is assured, and the application being reproduced is continuously executed based on the application management information 131 recorded on the storage medium 200 (Operation 605). If update is possible, the application management information (FIG. 3 or FIG. 4) stored in the local storage 201 is read (Operation 603) and combined with the application management information 131 recorded on the storage medium 200 in the system memory according to the combining rule (Operation 604). As a result of the combination, newly generated application management information is used to execute an application (Operation 605).

According to the present invention, a storage medium storing an application providing a programming function, and an apparatus and method of reproducing the application recorded on the storage medium and an application downloaded through a network are provided.

According to the present invention, a variety of applications offering a game function using moving-images, a function of displaying additional information while reproducing a portion of a moving-image, a function of reproducing information related to the movie such as the latest news about actors/actresses starring in the movie, events related to the movie, or updated subtitles, which are stored on a web page or in a database together with a movie, and interactive functions with users can be provided.

According to the present invention, it is possible to easily update and add application data, when the application includes errors and malfunction, which is not available when a storage medium is manufactured, or when it is necessary to update the application in order to provide additional functions which were not available when the storage medium was manufactured.

Although a few embodiments of the present invention have been shown and described, it would be appreciated by those skilled in the art that changes may be made in this embodiment without departing from the principles and spirit of the invention, the scope of which is defined in the claims and their equivalents.

1. An apparatus reproducing data recorded on a storage medium providing an interactive function, the apparatus comprising:
a reader reading the data recorded on the storage medium;
a local storage storing data downloaded from an external database via a network; and
a reproducer reproducing the data read from the storage medium and the downloaded data stored in the local storage,
wherein the reproducer includes an application manager to control the read data and the downloaded data to be reproduced together.

2. The apparatus of claim 1, wherein the application manager combines the read data with the downloaded data in a system memory and reproduces the combined data.

3. The apparatus of claim 2, wherein the read data and the downloaded data each include application data providing interactive functions and management information to control the application data, and
the application manager updates the management information read from the storage medium in the system memory using the management information downloaded and stored in a buffer of the apparatus.

4. The apparatus of claim 3, wherein the application manager replaces the management information read from the storage medium with the management information downloaded and stored in the buffer, and stores the replaced management information in the system memory when the management information downloaded and stored in the buffer is the same as the management information read from the storage medium.

5. The apparatus of claim 4, wherein the application manager compares names of applications included in the management information read from the storage medium and the management information downloaded and stored in the buffer, and/or file names of applications in order to check whether the management information downloaded and stored in the buffer is the same as the management information read from the storage medium.

6. The apparatus of claim 3, wherein the application manager adds the management information downloaded and stored in the buffer to the management information read from the storage medium, and stores the added management information in the system memory when the management information downloaded and stored in the buffer is not the same as the management information read from the storage medium.

7. The apparatus of claim 3, wherein the local storage includes separate storage regions divided by dividers of the storage medium, and stores the application data read from the storage medium and the downloaded application data and the management information read from the storage medium and downloaded management information in the divided storage regions.

8. The apparatus of claim 7, wherein the management information of the storage medium and the downloaded management information wherein each includes property information of the application and operation information of the application.

9. The apparatus of claim 8, wherein the property information of the application contains at least one of a name of the application data, a name of a file of the application data, a position of the file, version information of the application data, and title information including the application data.

10. The apparatus of claim 8, wherein the operation information of the application contains at least one of a starting and ending method of the application, a starting and ending time of the application, a suspend method and time of the application, preload information of the application data, and execution start parameter information.

11. The apparatus of claim 7, wherein the local storage stores at least one piece of downloaded application data and one piece of downloaded management information in each of divided storage regions.

12. The apparatus of claim 7, wherein the local storage stores at least one piece of downloaded application data and management information corresponding to at least one piece of the downloaded application data in each of divided storage regions.

13. The apparatus of claim 1, wherein the storage medium is easily removed from and inserted into the reproducing apparatus.

14. The apparatus of claim 13, wherein the storage medium is an optical disk capable of reading data using an optical device.

15. A method of reproducing data recorded on a storage medium providing an interactive function, the method comprising:
reading the data recorded on the storage medium;
storing data downloaded from an external database via a network on a local storage; and
combining the data read from the storage medium with the downloaded data stored in the local storage and reproducing the combined data.

16. The method of claim 15, wherein the data read from the storage medium and the downloaded and stored data include application data providing the interactive function with users and management information controlling execution of an application.

17. The method of claim 16, wherein the storing of the downloaded data comprises:
storing the application data and the management information in storage regions divided by dividers of the storage medium.

18. The method of claim 17, wherein the combining of the data comprises:
updating the management information read from the storage medium in a system memory using the downloaded and stored management information.

19. The method of claim 18, wherein the combining of the data comprises:
searching and reproducing the downloaded and stored management information when the storage medium is inserted into a reproducing apparatus, and replacing the management information read from the storage medium with the downloaded and stored management information and storing the replaced management information in the system memory when the downloaded and stored management information is the same as the management information read from the storage medium.

20. The method of claim 18, wherein the combining of the data comprises:
searching and reproducing the downloaded and stored management information when the storage medium is inserted into a reproducing apparatus, and adding the downloaded and stored management information to the management information read from the storage medium and storing the added management information in the system memory when the downloaded and stored management information is not the same as the management information read from the storage medium.

21. The apparatus of claim 1, wherein the data recorded on the storage medium and the data downloaded from the external database include moving-images data, application data and system data.

22. The apparatus of claim 21, wherein the system data includes start-up information, title information or application management information.

23. The apparatus of claim 22, wherein the application management information includes property information or operation information of the application data.

24. The apparatus of claim 3, wherein the management information of the application data downloaded to the local storage has a same structure as the management information of the application data recorded on the storage medium.

25. The apparatus of claim 1, wherein the local storage stores a plurality of pieces of application data and a plurality of pieces of application management information corresponding to each of the plurality of pieces of the application data.

26. The apparatus of claim 9, wherein the name of the application data is used to indicate correlations of the application data recorded on the storage medium and the application data downloaded to the local storage.

27. The method of claim 16, wherein when a local file name of a downloaded application data stored in the local storage is the same as the application data recorded on the storage medium, the application data recorded in the local storage is used to correct an error of the application data recorded on the storage medium or the application data recorded in the local storage medium is used to upgrade a version of the application data.

28. The method of claim 16, wherein when a local file name of a downloaded application data stored in the local storage is not the same as the application data recorded on the storage medium, the application data recorded in the local storage is used to provide additional functions which are not provided in the application data recorded on the storage medium.
